(19) United States
(12) Patent Application Publication
(10) Pub. No.: US 2006/0153240 A1
(43) Pub. Date: Jul. 13, 2006

(54) Radio packet signal transmission system, radio packet signal transmission terminal and radio packet signal transmission method used in these

(75) Inventor: Tomohiro Kikuma, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/327,485

(22) Filed: Jan. 9, 2006

(30) Foreign Application Priority Data
Jan. 12, 2005 (JP) 004628/2005

(51) Int. Cl. H04Q 7/24; H04J 3/16; H04J 3/22; H04J 3/24; H04Q 7/00

(52) U.S. Cl. 370/474; 370/328; 370/338; 370/469

(57) ABSTRACT

A radio packet signal transmission terminal is provided that can enhance transmission efficiency of existing radio packet transmission systems by incorporating therein, without any obstruction thereto, a terminal that can improve system throughput even though processing delays exceed an SIFS, without changing the SIFS. When a MAC data structure modification decision portion decides to modify MAC data, a dummy data attaching portion newly attaches dummy data meaningless as MAC data to data output from a MAC data signal generation portion to modify the structure of the MAC data. When a dummy data deletion portion receives information relating to attachment of dummy data output from a MAC data modification detection portion that indicates dummy data has been attached, the dummy data deletion portion deletes the dummy data after performing an error check using an FCS from the output of a MAC data signal decoding portion.

### BACKGROUND OF THE INVENTION

1. Field of the Invention

The present invention relates to a radio packet signal transmission system, a radio packet signal transmission terminal and a radio packet signal transmission method used in these, and more particularly to a radio packet signal transmission system that exerts an effect that enhances transmission efficiency.

2. Description of the Prior Art

A representative example of a radio packet signal transmission system is the IEEE (Institute of Electrical and Electronic Engineers) 802.11 system that is a standard for wireless LANs (Local Area Networks) (for example, see “Local and Metropolitan Area Networks: Wireless LAN 9.2 DCF” [ISO/IEC 8802-11: 1999(E) ANSI/IEEE Std 802.11, 1999 Edition]).

Hereunder, CSMA/CA (Carrier Sense Multiple Access with Collision Avoidance) that is an access method according to the above IEEE 802.11 system is described.

CSMA/CA is one kind of random access method, in which band reservation is not performed, that is the most common method in radio packet access. In order to reduce or avoid packet collisions, CSMA does not begin with the arrival of transmission data, and introduces an algorithm that monitors (performs carrier sensing for) the state of the channel that is used after arrival of transmission data. In order to apply a carrier sense method to radio communication, CSMA/CA is a method that is based on CSMA to which is also added an algorithm for collision avoidance.

The procedures of CSMA/CA are described hereunder. The term “collision avoidance” refers to an algorithm whereby, if a channel is vacant before the terminal transmits data, the terminal generates a random number and waits only for the time of that value. Since each terminal generates a random number independently, it is possible to reduce the probability of a collision occurring. The waiting time of only the time of the random number is referred to as a contention window (CW).

With respect to intervals between the respective packets, the terminals wait only a minimum time called “spacing” that takes into account switching between sending and receiving as well as propagation delay and the like. This spacing time is defined in the IEEE 802.11 system as IFS (Inter-Frame Spacing), and for example, SIFS (Short IFS), DIFS [DCF (Distributed Coordination Function) IFS] and EIFS (Extended IFS) are defined. Here, the relation that SIFS<DIFS holds, and SIFS has the shortest time among the IFS that implement CSMA/CA.

FIG. 3 illustrates a basic protocol that uses CSMA/CA. In FIG. 3, a case is assumed in which a radio packet communication system is configured by two terminals, terminal #1 and terminal #2. In FIG. 3, terminal #1 as the source waits for a DIFS time after the end of a busy state that signifies the channel is in use, and after confirming by carrier sensing that the channel is vacant it waits for a CW time and then performs carrier sensing again and if the channel is vacant it sends radio packets to terminal #2.

Terminal #2 completes processing of the packets within a radio packet time+SIFS time, and then transmits an ACK (acknowledgment) signal to terminal #1 as the source to notify terminal #1 that reception of the packets was successful. If terminal #1 can receive the ACK signal, the communication of a series of packets is complete.

FIG. 4 illustrates an example of the structure of a radio packet signal. Hereunder, processing of this radio packet signal is described using FIG. 4. In FIG. 4, a signal that is transmitted by radio waves in a radio packet signal transmission system is a radio packet signal, and the source data that is transmitted by the radio packet signal is MAC (Media Access Control) data that is created in a MAC sublayer.

A MAC data information signal is attached to the front of the MAC data and an FCS (Frame Check Sequence) for error checking of the data is added at the end of the MAC data. A radio packet signal that is created at a physical layer is converted to a radio data signal suited for radio communication by coding MAC data or the like.

As shown in FIG. 4, toward the front of a radio data signal are attached a known signal and a radio packet information signal. The known signal attached to the front of the radio packet signal is used to perform lead-in processing for demodulating the radio packet signal. As examples of this processing, synchronous processing of the radio packet signal, correction of a radio propagation path or correction of frequency offset generated by fluctuation of an oscillator or the like may be mentioned. The radio packet information signal is used to obtain information necessary for demodulation of the radio packet signal, such as the length of the data signal. A terminal can recognize the time required to demodulate a data signal using a MAC data information signal or information relating to the length of the data signal extracted from a radio packet information signal.

The radio data signal is demodulated and decoded with reflecting the result of processing the radio packet information signal. After decoding processing of the radio data signal, the MAC data signal is decoded. By checking the FCS data that was attached at the rear of the MAC data it is possible to determine whether or not the source data (MAC data) was correctly received. When reception was successful the receiving terminal generates an ACK signal and sends the radio packet signal to the source.

Other examples of radio packet signal transmission systems include technology that expands a service area without changing the SIFS that is defined for an existing radio packet transmission system by attaching dummy information toward the rear of packets in accordance with a radio propagation delay (for example, see Japanese Patent Laid-Open No. 11-127479).

### BRIEF SUMMARY OF THE INVENTION

However, it will be readily understood by a radio engineer that, in general, enhancement of reception performance results in an increase in the scale of the circuitry as well as processing delays. In a radio packet signal transmission system, assuming that an SIFS time that is already defined for the radio packet signal transmission system is redefined to be increased in order to allow an increase in processing delays resulting from enhancement of the reception performance. The system throughput is compared with the throughput of a conventional system that does not allow the SIFS time to be increased. Then, the system throughput is improved when the throughput increment as a result of a coverage expansion effect generated by enhancement of the reception performance is greater than the throughput reduction caused by the SIFS time increase.

This improvement effect will increase together with an increase in the radio packet signal time, that is, as the radio packet signal time/(radio packet signal time+SIFS time) approaches “1”. However, in a radio packet signal transmission system that uses the CSMA/CA system according to the conventional technology, it is necessary to restrict a reception processing delay at least within the SIFS time. This is because it is necessary to send an ACK within the SIFS time that is defined by the standards or the like for that system. If an individual was permitted to arbitrarily change the SIFS time, a problem would arise whereby it would no longer be possible to establish fairness of communication granted to each terminal configuring that system.

Further, if an ACK was sent after exceeding the defined SIFS time, the ACK would collide with a radio packet signal transmitted from another terminal that is observing the defined SIFS time and this would violate the system etiquette.

In addition, from the viewpoint of industrial development, as a method for addressing future needs with respect to wireless access with high-speed transmission rates, from the standpoint of early realization and cost reduction, a method that effectively utilizes and improves an existing radio packet signal transmission system is considered one of the optimal solutions.

However, in this case, it is important that interconnectivity is maintained between a terminal with reception performance that corresponds to an existing radio packet signal transmission system and a new terminal with high reception performance that has the capability to improve the throughput of the existing radio packet signal transmission system. Thus, from this viewpoint also it is not preferable to change the SIFS that is already defined.

In this respect, according to the technology disclosed in Japanese Patent Laid-Open No. 11-127479, since the amount of dummy information increases together with an increase in the number of terminals with a large radio propagation delay accommodated by a base station, the technology acts in a way that decreases the throughput of that system.

In view of the above described problems, a task in this field is to improve the throughput of an existing radio packet transmission system by incorporating into the system without any obstruction thereto a terminal which can improve the system throughput without changing the SIFS even if a processing delay exceeds the SIFS defined by the existing radio packet signal transmission system.

Therefore, an object of the present invention is to solve the above described problems and provide a radio packet signal transmission system that can incorporate into an existing radio packet transmission system without any obstruction thereto a terminal which can improve the system throughput without changing the SIFS even though a processing delay exceeds the SIFS and that can also improve the transmission efficiency of the existing radio packet transmission system, as well as a radio packet signal transmission terminal and a radio packet signal transmission method used in these.

A radio packet signal transmission system according to one aspect of this invention is a radio packet signal transmission system that carries out transmission of radio packet signals between terminals, wherein

a terminal on a sending side comprises means that attaches a predetermined data to a source data signal, means that performs modification processing of an information relating to a radio transmission time of a data signal, and means that attaches contents of the modification processing to a control data signal;

a terminal on a receiving side comprises means that performs either decoding processing or demodulation processing of the source data signal in accordance with the contents of the modification processing; and

the terminal on the sending side decides whether or not to attach the predetermined data to the source data signal in accordance with either a signal length or a reception quality of the source data signal.

A radio packet signal transmission system according to another aspect of this invention is a radio packet signal transmission system comprising a terminal including, on a sending side, means that performs coding processing of a source data signal, means that performs coding processing of a control data signal including an information relating to a radio transmission time of a data signal, means that forms a composite signal of a result obtained by coding processing of the source data signal and a result obtained by coding processing of the control data signal, means that modulates the composite signal to generate a radio packet signal, and means that makes a decision to transmit the radio packet signal in accordance with a radio usage state;

and on a receiving side, means that demodulates the radio packet signal, means that performs decoding of a control data signal from the demodulated radio packet signal, means that performs decoding and demodulation of a source data signal in accordance with a result of decoding information relating to a radio transmission time that is included in the control data signal, means that makes a success judgment regarding a result of decoding the data signal, and means that sends a reception success notification signal to a sender that sent the radio packet signal in accordance with the success judgment result for the decoding result; wherein,

on the sending side the terminal comprises means that attaches a predetermined data to the source data signal, means that performs modification processing of the information relating to the radio transmission time, and means that attaches the contents of the modification processing to the control data signal;

on the receiving side the terminal comprises means that performs either decoding processing or demodulation processing of the source data signal in accordance with the contents of the modification processing; and

on the sending side the terminal decides whether or not to attach the predetermined data to the source data signal in accordance with either a signal length or a reception quality of the source data signal.

A radio packet signal transmission terminal according to a further aspect of this invention is a radio packet signal transmission terminal that conducts transmission of radio packet signals with another terminal, wherein

on a sending side the terminal comprises means that attaches a predetermined data to a source data signal, means that performs modification processing of an information relating to a radio transmission time of a data signal, and means that attaches contents of the modification processing to a control data signal;

on a receiving side the terminal comprises means that performs either decoding processing or demodulation processing of the source data signal in accordance with the contents of the modification processing; and

on the sending side the terminal decides whether or not to attach the predetermined data to the source data signal in accordance with either a signal length or a reception quality of the source data signal.

A radio packet signal transmission terminal according to a further aspect of this invention is a radio packet signal transmission terminal that includes, on a sending side, means that performs coding processing of a source data signal, means that performs coding processing of a control data signal including an information relating to a radio transmission time of a data signal, means that forms a composite signal of a result obtained by coding processing of the source data signal and a result obtained by coding processing of the control data signal, means that modulates the composite signal to generate a radio packet signal, and means that makes a decision to transmit the radio packet signal in accordance with a radio usage state;

and on a receiving side, means that demodulates the radio packet signal, means that performs decoding of a control data signal from the demodulated radio packet signal, means that performs decoding and demodulation of the source data signal in accordance with a result of decoding the information relating to a radio transmission time that is included in the control data signal, means that makes a success judgment regarding a result of decoding the data signal, and means that sends a reception success notification signal to a sender that sent the radio packet signal in accordance with the success judgment result for the decoding result; wherein

on the sending side the terminal comprises means that attaches a predetermined data to the source data signal, means that performs modification processing of the information relating to the radio transmission time, and means that attaches the contents of the modification processing to the control data signal;

on the receiving side the terminal comprises means that performs either decoding processing or demodulation processing of the source data signal in accordance with the contents of the modification processing; and

on the sending side the terminal decides whether or not to attach the predetermined data to the source data signal in accordance with either a signal length or a reception quality of the source data signal.

A radio packet signal transmission method according to a still further aspect of this invention is a radio packet signal transmission method that carries out transmission of radio packet signals between terminals, wherein

a terminal on a sending side executes processing that attaches a predetermined data to a source data signal, processing that conducts modification processing of an information relating to a radio transmission time of a data signal, and processing that attaches contents of the modification processing to a control data signal;

a terminal on a receiving side executes processing that performs either decoding processing or demodulation processing of the source data signal in accordance with the contents of the modification processing; and

the terminal on the sending side decides whether or not to attach the predetermined data to the source data signal in accordance with either a signal length or a reception quality of the source data signal.

A radio packet signal transmission method according to another aspect of this invention is a radio packet signal transmission method used in a radio packet signal transmission system comprising a terminal including, on a sending side, means that performs coding processing of a source data signal, means that performs coding processing of a control data signal including an information relating to a radio transmission time of a data signal, means that forms a composite signal of a result obtained by coding processing of the source data signal and a result obtained by coding processing of the control data signal, means that modulates the composite signal to generate a radio packet signal, and means that makes a decision to transmit the radio packet signal in accordance with a radio usage state;

and on a receiving side, means that demodulates the radio packet signal, means that performs decoding of a control data signal from the demodulated radio packet signal, means that performs decoding and demodulation of a source data signal in accordance with a result of decoding the information relating to a radio transmission time that is included in the control data signal, means that makes a success judgment regarding a result of decoding the data signal, and means that sends a reception success notification signal to a sender that sent the radio packet signal in accordance with the success judgment result for the decoding result; wherein

on the sending side the terminal implements means that attaches a predetermined data to the source data signal, means that performs modification processing of the information relating to the radio transmission time, and means that attaches the contents of the modification processing to the control data signal;

on the receiving side the terminal implements means that performs either decoding processing or demodulation processing of the source data signal in accordance with the contents of the modification processing; and

on the sending side, the terminal decides whether or not to attach the predetermined data to the source data signal in accordance with either a signal length or a reception quality of the source data signal.

More specifically, according to the radio packet signal transmission system of this invention, as sending means a terminal has means that performs coding processing of a source data signal, means that performs coding processing of a control data signal including an information relating to a radio transmission time of a data signal, means that forms a composite signal of a result obtained by coding processing of the source data signal and a result obtained by coding processing of the control data signal, means that modulates the composite signal to generate a radio packet signal, and means that makes a decision to transmit the radio packet signal in accordance with a radio usage state.

Further, according to the radio packet signal transmission system of this invention, as receiving means a terminal has means that demodulates a radio packet signal, means that performs decoding of a control data signal from the demodulated radio packet signal, means that performs decoding and demodulation of a source data signal in accordance with a result of decoding an information relating to a radio transmission time that is included in the control data signal, means that makes a success judgment regarding a result of decoding the data signal, and means that sends a reception success notification signal to a sender that sent the radio packet signal in accordance with the success judgment result for the decoding result.

In the radio packet signal transmission system of this invention, a terminal having the above described sending means and receiving means has, as sending means, means that attaches a predetermined data to the source data signal, means that performs modification processing of an information relating to a radio transmission time, and means that attaches contents of the modification processing to the control data signal, and as receiving means, means that performs either decoding processing or demodulation processing of the source data signal in accordance with the contents of the modification processing; and that the sending means decides whether or not to attach the predetermined data to the source data signal in accordance with either a signal length or a reception quality of the source data signal.

Thus, according to the radio packet signal transmission system of this invention it is possible to overcome a problem that existed in a radio packet signal transmission system according to the conventional system, by incorporating into an existing radio packet transmission system without any obstruction thereto a terminal which can improve the system throughput even though a processing delay exceeds the SIFS, without changing the SIFS [Short IFS (Inter-Frame Spacing)] that is defined for the existing radio packet transmission system, and to improve the transmission efficiency of the existing radio packet transmission system.

By employing the configuration and operation described hereunder, this invention enables the incorporation into an existing radio packet transmission system without any obstruction thereto of a terminal which can improve the system throughput even though a processing delay exceeds the SIFS, without changing the SIFS, and also enables enhancement of the transmission efficiency of the existing radio packet transmission system.

### BRIEF DESCRIPTION OF THE DRAWINGS

FIG. 1 is a block diagram showing the configuration of a terminal of a radio packet signal transmission system according to an embodiment of this invention;

FIG. 2 is a view showing the configuration of MAC data and a radio packet signal in an embodiment of this invention;

FIG. 3 is a view for explaining the basic protocol of CSMA/CA; and

FIG. 4 is a view showing the configuration of the conventional MAC data and radio packet signal.

### DETAILED DESCRIPTION OF THE PREFERRED EMBODIMENTS

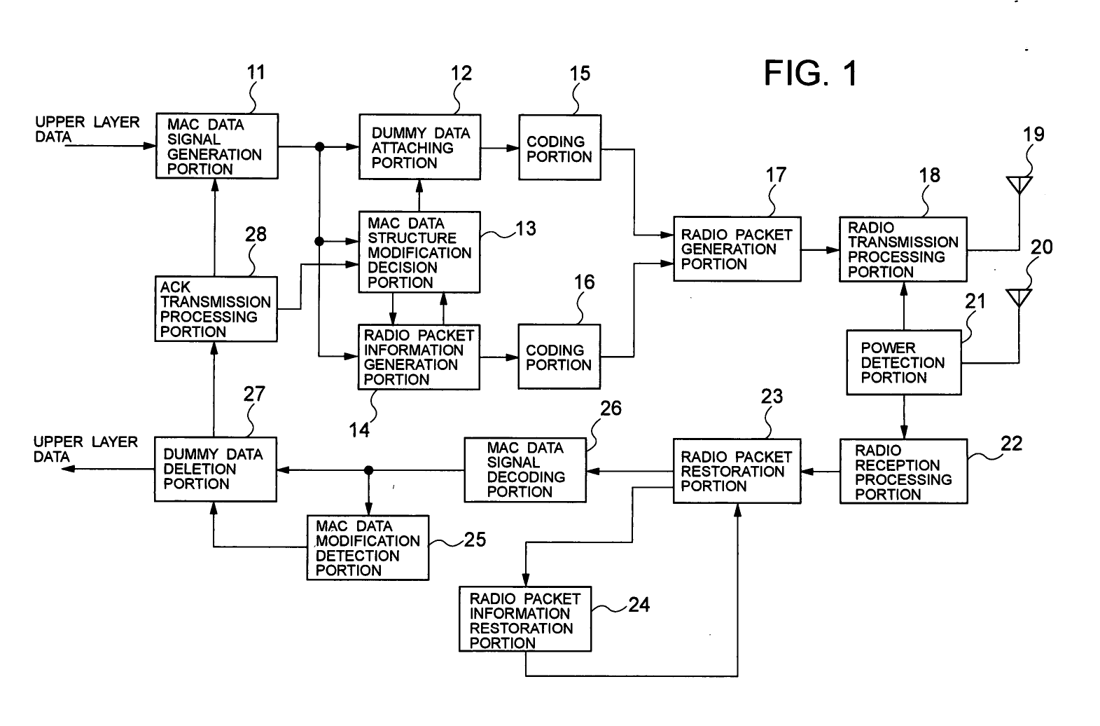

Next, an embodiment of this invention will be described referring to the drawings. FIG. 1 is a block diagram showing the configuration of a terminal of a radio packet signal transmission system according to an embodiment of this invention. In FIG. 1, the transmission configuration and reception configuration of a radio packet signal transmission terminal are combined into one configuration and described.

In FIG. 1, the radio packet signal transmission terminal according to an embodiment of this invention comprises a MAC (Media Access Control) data signal generation portion 11, a dummy data attaching portion 12, a MAC data structure modification decision portion 13, a radio packet information generation portion 14, coding portions 15 and 16, a radio packet generation portion 17, a radio transmission processing portion 18, a transmission antenna 19, a reception antenna 20, a power detection portion 21, a radio reception processing portion 22, a radio packet restoration portion 23, a radio packet information restoration portion 24, a MAC data modification detection portion 25, a MAC data signal decoding portion 26, a dummy data deletion portion 27, and an ACK (acknowledgment) transmission processing portion 28.

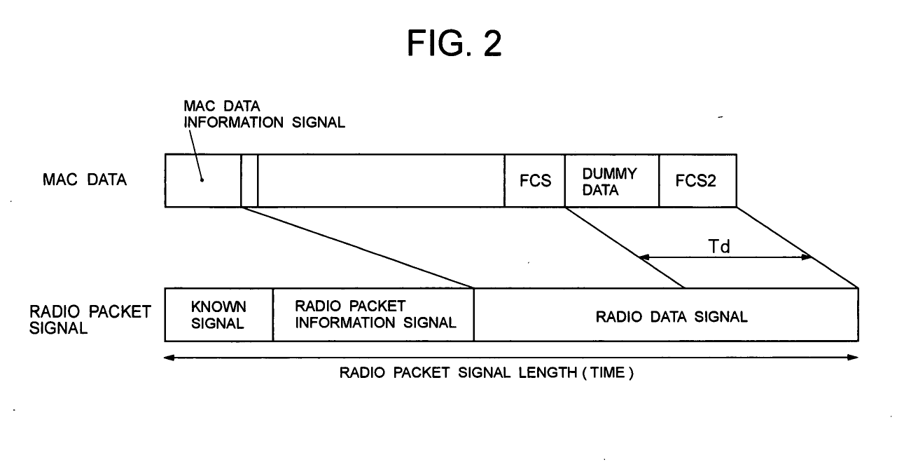

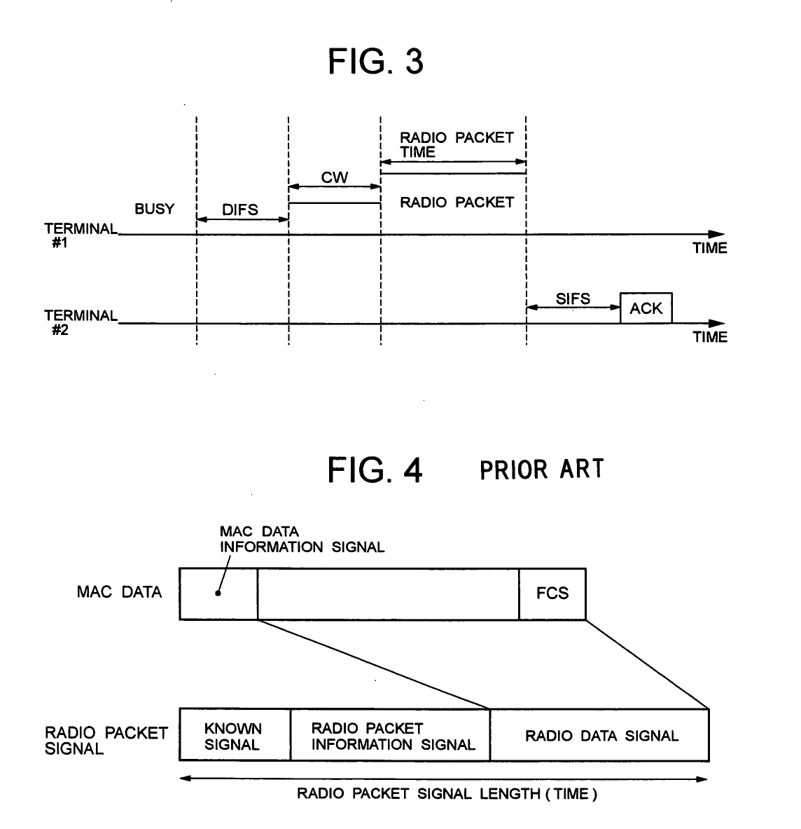

FIG. 2 is a view showing the configuration of MAC data and a radio packet signal in an embodiment of this invention. The configuration and operation of a radio packet signal transmission terminal according to the embodiment of this invention will be described referring to FIG. 1 and FIG. 2. Hereunder, the transmission configuration is described first.

In transmission processing, initially a MAC data signal is generated by the MAC data signal generation portion 11. Then, the MAC data structure modification decision portion 13 decides whether or not there is a modification to the MAC data and notifies the result to the dummy data attaching portion 12 and the radio packet information generation portion 14.

When the MAC data structure modification decision portion 13 decides to modify the MAC data, the dummy data attaching portion 12 newly attaches dummy data that is meaningless as MAC data to the output data of the MAC data signal generation portion 11 in accordance with the decision result, to thereby modify the structure of the MAC data. The structure of the MAC data when the MAC data structure modification decision portion 13 decided to modify the MAC data structure is shown in FIG. 2.

The MAC data structure according to the prior art is the structure shown in the aforementioned FIG. 4, and this structure is employed when a decision to modify the MAC data structure is not made. The differences between these two MAC data structures are the attachment of dummy data of a given time amount after the conventional FCS (Frame check sequence) and a new FCS (FCS2 of FIG. 2) that takes into account the data up to the conventional FCS and the attached dummy data, and changes to the radio packet time and MAC data modification information included in the MAC data information signal in accordance therewith.

The radio packet information generation portion 14 calculates the radio packet length when sending the data as a radio packet from the MAC data signal generation portion 11, and generates and attaches data relating thereto. The radio packet information generation portion 14 also changes the data relating to the radio packet length in accordance with the decision result of the MAC data structure modification decision portion 13.

The coding portion 15 performs processing such as encoding of the output of the dummy data attaching portion 12 that is suitable for radio communication. The coding portion 16 performs processing such as encoding of the output of the radio packet information generation portion 14 that is suitable for radio communication. The radio packet generation portion 17 combines the outputs of the coding portions 15 and 16 to generate the radio packet signal of FIG. 2 or FIG. 4.

The radio transmission processing portion 18 performs digital-to-analog signal processing as transmission processing for a radio packet signal of the output of the radio packet generation portion 17. The output of the radio transmission processing portion 18 is sent by radio transmission into the air through the transmission antenna 19. In this case, the radio transmission is conducted in accordance with the protocol of the aforementioned CSMA/CA (Carrier Sense Multiple Access with Collision Avoidance), and the usage state of a channel is determined from the result of a power measurement by the power detection portion 21 through the reception antenna 20 with respect to the channel that is used, and that result is notified to the radio transmission processing portion 18. If the radio transmission processing portion 18 receives a notification that permits use of the channel from the power detection portion 21, it transmits the radio packet signal through the transmission antenna 19.

Next, the reception configuration will be described. For reception of a radio packet signal, the power detection portion 21 performs power detection through the reception antenna 20 to determine the reception of a radio packet signal, and that result is notified to the radio reception processing portion 22. The radio reception processing portion 22 performs demodulation processing through an analog-to-digital signal processing circuit (not shown).

The radio reception processing portion 22 performs lead-in processing for demodulating the radio packet signal using a known signal shown in the radio packet signal of FIG. 2 or FIG. 4. As examples of lead-in processing, synchronous processing of a radio packet signal, correction of a radio propagation path or correction of frequency offset generated by fluctuation of an oscillator or the like may be mentioned.

The radio packet restoration portion 23 performs restoration processing for the radio packet signal. In this case, the term “restoration processing” refers to restoration of a radio packet information signal and a radio data signal excluding the known signal shown in the radio packet signal of FIG. 2 or FIG. 4. The radio packet information restoration portion 24 performs decoding of the radio packet information signal shown in FIG. 2 or FIG. 4 for the output of the radio packet restoration portion 23, and outputs the result to the radio packet restoration portion 23. The radio packet restoration portion 23 then performs restoration processing for the radio data signal based on the radio packet information signal.

The MAC data signal decoding portion 26 receives the radio data signal shown in FIG. 2 or FIG. 4 that was restored by the radio packet restoration portion 23 and decodes the MAC data. The MAC data modification detection portion 25 extracts the MAC data information signal shown in FIG. 2 or FIG. 4 and detects the existence or non-existence of a MAC data modification.

The dummy data deletion portion 27 receives information relating to attachment of dummy data that is output from the MAC data modification detection portion 25, and when dummy data is attached, it deletes the dummy data from the output of the MAC data signal decoding portion 26 after performing an error check using the FCS.

When dummy data is not attached, the dummy data deletion portion 27 does not perform any processing. When the dummy data deletion portion 27 determines by the error check using the FCS that there is no error in the radio packet signal, it sends a notification to the ACK transmission processing portion 28, whereupon ACK transmission data is created and transmission processing is performed through the MAC data signal generation portion 21 to transmit an ACK signal from the transmission antenna 19.

In this case, the FCS used by the dummy data deletion portion 27 refers to the FCS shown in FIG. 4 in a case where there is no MAC data modification, and refers to the FCS2 shown in FIG. 2 in a case where there is a MAC data modification. In this connection, the radio packet restoration portion 23 switches the reception processing method in accordance with the existence or non-existence of a MAC data modification. For example, a configuration may be employed in which the radio packet restoration portion 23 comprises a first reception processing circuit and a second reception processing circuit with a high level of reception performance although it also has more processing delays than the first reception processing circuit. Thus, when a MAC data modification is not detected the radio packet restoration portion 23 uses the first reception processing circuit, and when a MAC data modification is detected the radio packet restoration portion 23 uses the second reception processing circuit.

In this connection, in FIG. 2, a time delay amount Td produced by attachment of dummy data is, for example, set after taking into account the increase in the processing delay time produced by introduction of the second reception processing circuit. Although in one embodiment of this invention the transmission antenna 19 and the reception antenna 20 are described separately in order to facilitate explanation, a single antenna may be used for these by switching the use thereof at the time of transmission and reception.

A first portion that forms the backbone of one embodiment of this invention is the provision of the MAC data structure modification decision portion 13, the dummy data attaching portion 12, the MAC data modification detection portion 25 and the dummy data deletion portion 27.

When the MAC data is not being modified, the MAC data structure modification decision portion 13 and the dummy data attaching portion 12 form the MAC data structure in accordance with the prior art as shown in FIG. 4, and when the MAC data is being modified, they form the MAC data structure as shown in FIG. 2 that is a feature of one embodiment of this invention.

In this connection, a decision to modify the MAC data by the MAC data structure modification decision portion 13 may be in accordance with the MAC data count per radio packet signal output from the MAC data signal generation portion 11. In this case, for example, a method may be employed whereby if the MAC data count per radio packet signal fulfills a condition that a time increment Td produced by the additional amount of dummy data shown in FIG. 2 is smaller than a given threshold in comparison with the radio packet length, the MAC data structure modification decision portion 13 decides to modify the MAC data structure, and if the above described condition is not fulfilled it does not decide to modify the MAC data structure.

Further, a decision to modify the MAC data by the MAC data structure modification decision portion 13 may be in accordance with an ACK transmit probability at the ACK transmission processing portion 28. In this case, for example, a method may be employed whereby if a condition is fulfilled that the ACK transmit probability with respect to past reception packets is lower than a given threshold the MAC data structure modification decision portion 13 decides to modify the MAC data structure, and if the above condition is not fulfilled it does not decide to modify the MAC data structure.

A difference between the two MAC data structures shown in FIG. 2 and FIG. 4 is the attachment of dummy data of a given time amount and a new FCS (FCS2 of FIG. 2) that takes into account the data up to the conventional FCS and the attached dummy data in the MAC data structure shown in FIG. 2. Thus, since radio packet information such as the attachment of dummy data is reflected in the radio packet information generation portion 14, the FCS2 can be recognized as a conventional FCS by a conventional terminal that receives this radio packet signal.

Further, in a terminal equipped with the technology of this embodiment, since dummy data that is attached can be detected by the MAC data modification detection portion 25, it is possible to make a separation between dummy data that is meaningless as MAC data and the MAC data that must be provided as upper layer data.

A second portion that forms the backbone of one embodiment of this invention is the feature of switching the reception processing method in the radio packet restoration portion 23 in accordance with the existence or non-existence of a MAC data modification. For example, by equipping the radio packet restoration portion 23 with a first reception processing circuit and a second reception processing circuit with a high level of reception performance although it also has more processing delays than the first reception processing circuit, when a MAC data modification is not detected the radio packet restoration portion 23 can use the first reception processing circuit, and when a MAC data modification is detected the radio packet restoration portion 23 can use the second reception processing circuit.

The effect of the first portion that forms the backbone of one embodiment of this invention is the provision of interconnectivity between a terminal A that is equipped with existing technology of a radio packet communication system according to the prior art and a terminal B that is equipped with the technology according to an embodiment of this invention. Thus, as described in the foregoing, by applying the first portion that forms the backbone of one embodiment of this invention, even when a radio packet signal of terminal B that underwent a MAC data modification is received by terminal A, an FCS error will not occur in terminal A.

Further, the effect of the second portion that forms the backbone of one embodiment of this invention is that, when MAC data was modified, since there is an extension to the radio packet time caused by the amount of dummy data as data that is meaningless as MAC data, it is possible to use a receiving circuit with higher performance than the receiving circuit of a conventional terminal even though processing delays are greater by allocating this time extension amount as a processing delay time that exceeded the SIFS of the second reception processing circuit, and it is also possible to transmit an ACK signal in the SIFS time defined by the conventional radio packet communication system.

Furthermore, for a method that effectively uses the above described second reception processing circuit, since it is considered that if a time increment Td produced by an additional amount of dummy data fulfills the condition that it is smaller than a given threshold in comparison to the radio packet length, the time increment produced by attachment of the dummy data will not have an effect of reducing throughput, the probability of using the second reception processing circuit is increased by modifying the MAC data structure.

In addition, according to a method that effectively uses the second reception processing circuit, because FCS errors, i.e. packet reception errors, increase and communication quality is poor when the ACK transmit probability with respect to past reception packets is lower than a certain threshold, the probability of using the second reception processing circuit may be increased by modifying the MAC data structure.

Thus, according to this embodiment it is possible to overcome a problem that existed with radio packet signal transmission systems according to the conventional system by incorporating into an existing radio packet transmission system without any obstruction thereto a terminal which can improve the system throughput even though a processing delay exceeds the SIFS, without changing the SIFS that is defined for the existing radio packet transmission system, and to improve the transmission efficiency of the existing radio packet transmission system.

What is claimed is:

1. A radio packet signal transmission system that carries out transmission of radio packet signals between terminals, wherein
a terminal on a sending side has means that attaches a predetermined data to a source data signal, means that performs modification processing of an information relating to a radio transmission time of a data signal, and means that attaches contents of the modification processing to a control data signal;
a terminal on a receiving side has means that performs either decoding processing or demodulation processing of the source data signal in accordance with the contents of the modification processing; and
the terminal on the sending side decides whether or not to attach the predetermined data to the source data signal in accordance with either a signal length or a reception quality of the source data signal.

2. A radio packet signal transmission system comprising a terminal including, on a sending side, means that performs coding processing of a source data signal, means that performs coding processing of a control data signal including an information relating to a radio transmission time of a data signal, means that forms a composite signal of a result obtained by coding processing of the source data signal and a result obtained by coding processing of the control data signal, means that modulates the composite signal to generate a radio packet signal, and means that makes a decision to transmit the radio packet signal in accordance with a radio usage state;
and on a receiving side, means that demodulates the radio packet signal, means that performs decoding of the control data signal from the demodulated radio packet signal, means that performs decoding and demodulation of the source data signal in accordance with a result of decoding the information relating to a radio transmission time that is included in the control data signal, means that makes a success judgment regarding a result of decoding the data signal, and means that sends a reception success notification signal to a sender that sent the radio packet signal in accordance with the success judgment result for the decoding result; wherein,
on the sending side the terminal has means that attaches a predetermined data to the source data signal, means that performs modification processing of the information relating to the radio transmission time, and means that attaches the contents of the modification processing to the control data signal;
on the receiving side the terminal has means that performs either decoding processing or demodulation processing of the source data signal in accordance with the contents of the modification processing; and
on the sending side the terminal decides whether or not to attach the predetermined data to the source data signal in accordance with either a signal length or a reception quality of the source data signal.

3. The radio packet signal transmission system according to claim 2, which is configured by at least two or more of the terminals.

4. A radio packet signal transmission terminal that conducts transmission of radio packet signals with another terminal, wherein,
on a sending side the terminal has means that attaches a predetermined data to a source data signal, means that performs modification processing of an information relating to a radio transmission time of a data signal, and means that attaches contents of the modification processing to a control data signal;
on a receiving side the terminal has means that performs either decoding processing or demodulation processing of the source data signal in accordance with the contents of the modification processing; and
on the sending side the terminal decides whether or not to attach the predetermined data to the source data signal in accordance with either a signal length or a reception quality of the source data signal.

5. A radio packet signal transmission terminal that includes, on a sending side, means that performs coding processing of a source data signal, means that performs coding processing of a control data signal including an information relating to a radio transmission time of a data signal, means that forms a composite signal of a result obtained by coding processing of the source data signal and a result obtained by coding processing of the control data signal, means that modulates the composite signal to generate a radio packet signal, and means that makes a decision to transmit the radio packet signal in accordance with a radio usage state;
and on a receiving side, means that demodulates the radio packet signal, means that performs decoding of a control data signal from the demodulated radio packet signal, means that performs decoding and demodulation of a source data signal in accordance with a result of decoding the information relating to a radio transmission time that is included in the control data signal, means that makes a success judgment regarding a result of decoding the data signal, and means that sends a reception success notification signal to a sender that sent the radio packet signal in accordance with the success judgment result for the decoding result; wherein,
on the sending side the terminal has means that attaches a predetermined data to the source data signal, means that performs modification processing of the information relating to the radio transmission time, and means that attaches the contents of the modification processing to the control data signal;
on the receiving side the terminal has means that performs either decoding processing or demodulation processing of the source data signal in accordance with the contents of the modification processing; and
on the sending side the terminal decides whether or not to attach the predetermined data to the source data signal in accordance with either a signal length or a reception quality of the source data signal.

6. A radio packet signal transmission method that carries out transmission of radio packet signals between terminals, wherein
a terminal on a sending side executes processing that attaches a predetermined data to a source data signal, processing that performs modification processing of an information relating to a radio transmission time of a data signal, and processing that attaches contents of the modification processing to a control data signal;
a terminal on a receiving side executes processing that performs either decoding processing or demodulation processing of the source data signal in accordance with the contents of the modification processing; and
the terminal on the sending side decides whether or not to attach the predetermined data to the source data signal in accordance with either a signal length or a reception quality of the source data signal.

7. A radio packet signal transmission method that is used in a radio packet signal transmission system comprising a terminal including, on a sending side, means that performs coding processing of a source data signal, means that performs coding processing of a control data signal including an information relating to a radio transmission time of a data signal, means that forms a composite signal of a result obtained by coding processing of the source data signal and a result obtained by coding processing of the control data signal, means that modulates the composite signal to generate a radio packet signal, and means that makes a decision to transmit the radio packet signal in accordance with a radio usage state;
and on a receiving side, means that demodulates the radio packet signal, means that performs decoding of a control data signal from the demodulated radio packet signal, means that performs decoding and demodulation of a source data signal in accordance with a result of decoding the information relating to a radio transmission time that is included in the control data signal, means that makes a success judgment regarding a result of decoding the data signal, and means that sends a reception success notification signal to a sender that sent the radio packet signal in accordance with the success judgment result for the decoding result; wherein,
on the sending side the terminal implements means that attaches a predetermined data to the source data signal, means that performs modification processing of the information relating to the radio transmission time, and means that attaches the contents of the modification processing to the control data signal;
on the receiving side the terminal implements means that performs either decoding processing or demodulation processing of the source data signal in accordance with the contents of the modification processing; and
on the sending side the terminal decides whether or not to attach the predetermined data to the source data signal in accordance with either a signal length or a reception quality of the source data signal.

8. The radio packet signal transmission method according to claim 7, which is configured by at least two or more of the terminals.

9. The radio packet signal transmission system according to claim 1, wherein the source data signal is MAC (Media Access Control) data, and the predetermined data attached to the source data signal comprises dummy data of a certain time amount and a new FCS (Frame Check Sequence) that takes into account data up to a conventional FCS and the dummy data.

10. The radio packet signal transmission terminal according to claim 4, wherein the source data signal is MAC (Media Access Control) data, and the predetermined data attached to the source data signal comprises dummy data of a certain time amount and a new FCS (Frame Check Sequence) that takes into account data up to a conventional FCS and the dummy data.

11. The radio packet signal transmission method according to claim 6, wherein the source data signal is MAC (Media Access Control) data, and the predetermined data attached to the source data signal comprises dummy data of a certain time amount and a new FCS (Frame Check Sequence) that takes into account data up to a conventional FCS and the dummy data.
